(19) United States
(12) Patent Application Publication
(10) Pub. No.: US 2018/0025364 A1
(43) Pub. Date: Jan. 25, 2018

(54) INFORMATION PROCESSING APPARATUS, INFORMATION PROCESSING METHOD, AND PROGRAM

(71) Applicant: NEC Personal Computers, Ltd., Tokyo (JP)

(72) Inventor: Hiroshi Nakaji, Tokyo (JP)

(73) Assignee: NEC Personal Computers, Ltd., Tokyo (JP)

(21) Appl. No.: 15/615,960

(22) Filed: Jun. 7, 2017

(30) Foreign Application Priority Data
Jul. 20, 2016 (JP) 2016142633

(51) Int. Cl. G06Q 30/02; G06F 17/30; G06F 17/27

(52) U.S. Cl. CPC G06Q 30/0201; G06F 17/2715; G06F 17/3053; G06F 17/30554; G06F 17/30011

(57) ABSTRACT

An object of the present invention is to provide an information processing apparatus capable of selecting a variety of contents associated with a specified article. The information processing apparatus according to the present invention is characterized to calculate a first word feature value indicative of the appearance frequency of each word in a specified document, calculate a second word feature value indicative of the appearance frequency of a word in the description of a commercial product, calculate a degree of similarity between the specified document and the commercial product based on the first word feature value of the specified document and the second word feature value of the commercial product, select a first commercial product associated with the specified document based on the degree of similarity, and select a second commercial product associated with the specified document based on diversity calculated from the second word feature value of the selected first commercial product and the second word feature value of each of the unselected commercial products, and the degree of similarity.

### FIELD OF THE INVENTION

The present invention relates to an information processing apparatus, an information processing method, and a program.

### BACKGROUND OF THE INVENTION

Recently, enormous amounts of information and data have been provided from the Internet and broadcast networks, and the kinds of provided information have also been diversified. Further, the number of users to acquire information from the Internet and broadcast networks has increased. In such a situation, there is already known a system in which a provider providing contents using the Internet or broadcast networks analyzes an article or the like being viewed by a user to recommend a content associated with the article.

A technique associated with such a content recommendation system mentioned above is disclosed, for example, in Patent Document 1. Patent Document 1 discloses a technique for calculating a degree of similarity between an article being viewed by a user and information associated with a commercial product or service (e.g., the name of the commercial product, the description of the commercial product, reviews by consumers who used the commercial product, and the like) pre-searched from commercial products or services based on a keyword(s) determined to be high in degree of importance in the article being viewed by the user to provide, to the user, a commercial product or service whose degree of similarity is a predetermined threshold value or larger.

[Patent Document 1] Japanese Patent Application Publication No. 2015-022555

### SUMMARY OF THE INVENTION

However, for example, in the conventional technique disclosed in Patent Document 1, only a content high in degree of similarity to a viewing article is provided as a recommended content. Therefore, if two or more contents are to be recommended for one article, the contents will be searched inevitably based on a specific keyword and hence the recommendation of the acquired contents could be biased. Even in the case of the same content, if the sources from which the content is acquired are different, the content will be handled and recommended as different contents. In this case, the user may feel uncomfortable with the display of two or more pieces of the same content next to each other. Under such a situation, it is desired to establish a content recommendation system capable of recommending a variety of contents associated with a viewing article.

The present invention has been made in view of the above circumstances, and it is an object thereof to provide an information processing apparatus capable of selecting a variety of contents associated with a specified article.

An information processing apparatus according to the present invention includes: a document analysis section that calculates a first word feature value indicative of the appearance frequency of each word in a specified document; a commercial product analysis section that calculates a second word feature value indicative of the appearance frequency of each word in the description of a commercial product; a degree-of-similarity calculating section that calculates a degree of similarity between the specified document and the commercial product based on the first word feature value of the specified document and the second word feature value of the commercial product; a first commercial product selecting section that selects a first commercial product associated with the specified document based on the degree of similarity; and a second commercial product selecting section that selects a second commercial product associated with the specified document based on diversity calculated from the second word feature value of the selected first commercial product and the second word feature value of each of unselected commercial products, and the degree of similarity.

An information processing method according to the present invention includes: calculating a first word feature value indicative of the appearance frequency of each word in a specified document; calculating a second word feature value indicative of the appearance frequency of each word in the description of a commercial product; calculating a degree of similarity between the specified document and the commercial product based on the first word feature value of the specified document and the second word feature value of the commercial product; selecting a first commercial product associated with the specified document based on the degree of similarity; and selecting a second commercial product associated with the specified document based on diversity calculated from the second word feature value of the selected first commercial product and the second word feature value of each of unselected commercial products, and the degree of similarity.

A program for realizing information processing according to the present invention causes a computer to execute: calculating a first word feature value indicative of the appearance frequency of each word in a specified document; calculating a second word feature value indicative of the appearance frequency of each word in the description of a commercial product; calculating a degree of similarity between the specified document and the commercial product based on the first word feature value of the specified document and the second word feature value of the commercial product; selecting a first commercial product associated with the specified document based on the degree of similarity; and selecting a second commercial product associated with the specified document based on diversity calculated from the second word feature value of the selected first commercial product and the second word feature value of each of unselected commercial products, and the degree of similarity.

According to the present invention, a variety of contents associated with a specified article can be selected.

### BRIEF DESCRIPTION OF THE DRAWINGS

FIG. 1 is a hardware configuration diagram of an information processing apparatus 1 according to an embodiment of the present invention.

FIG. 2 is a functional block diagram of the information processing apparatus 1 according to the embodiment of the present invention.

FIG. 3 is a diagram illustrating an example of a specified document according to the embodiment of the present invention.

FIG. 4 is a table illustrating an example of grouping words according to the embodiment of the present invention.

FIG. 5 is a table illustrating an example of specified document analysis results according to the embodiment of the present invention.

FIG. 6 is a diagram illustrating examples of commercial products according to the embodiment of the present invention.

FIG. 7 is a table illustrating an example of commercial product analysis results according to the embodiment of the present invention.

FIG. 8 is a table illustrating the degrees of similarity of the commercial products to the specified document according to the embodiment of the present invention.

FIG. 9 is a table illustrating an example of selecting commercial products based on the degree of similarity and diversity according to the embodiment of the present invention.

FIG. 10 is a table illustrating an example of selecting a commercial product based on the degree of similarity and diversity according to the embodiment of the present invention.

FIG. 11 is a table illustrating an example of selecting a commercial product based on the degree of similarity and diversity according to the embodiment of the present invention.

FIG. 12 is a flowchart illustrating an example of selecting commercial products based on the degree of similarity and diversity according to the embodiment of the present invention.

### DETAILED DESCRIPTION OF THE INVENTION

An embodiment of the present invention will be described in detail below.

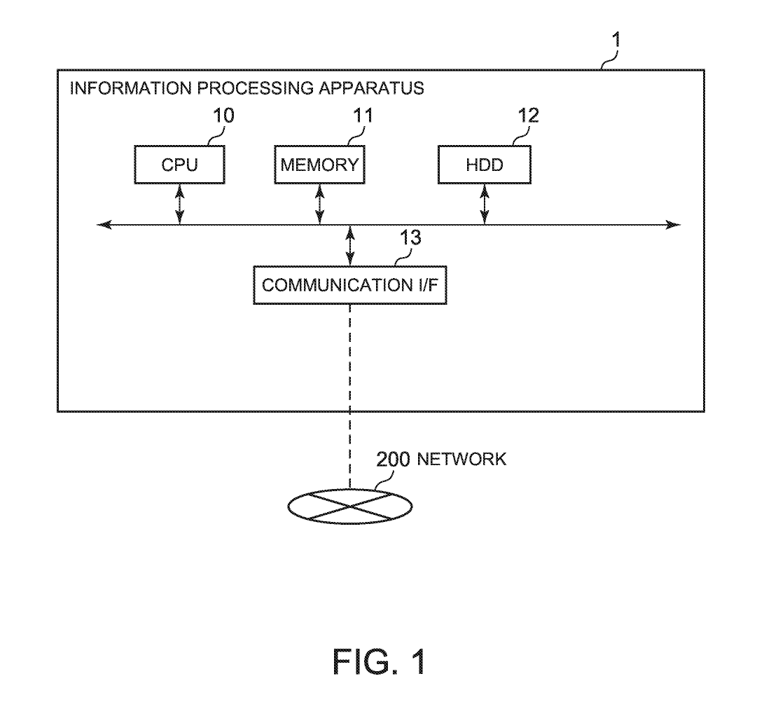

Referring first to FIG. 1, the hardware configuration of an information processing apparatus 1 of the embodiment will be described. Here, for example, the information processing apparatus is an information terminal or the like connectable to a network, such as a personal computer, a tablet terminal, or a smartphone. The information processing apparatus may also be a host computer or a server, which originates a processing request to multiple computers through a network. Note that the configuration of the information processing apparatus 1 is not necessarily required to have the same configuration as that illustrated in FIG. 1, and it is only necessary to include hardware capable of implementing the embodiment. For example, in the case of a personal computer, a tablet terminal, or a smartphone, the information processing apparatus may include input devices such as a mouse and a keyboard composed of input keys, a display device using a panel such as liquid crystal or organic EL, an optical drive for reading and writing data stored on a CD or a DVD, and the like.

The information processing apparatus 1 includes a CPU 10 that executes a predetermined program to control the entire information processing apparatus 1, a memory 11 composed of a read-only nonvolatile memory, such as a mask ROM, an EPROM, or an SSD, which stores a program to be read by the CPU 10 when the information processing apparatus 1 is powered on, a working volatile memory, such as an SRAM or a DRAM, used by the CPU 10 to read the program and temporarily write data generated by arithmetic processing or the like, and an HDD 12 capable of holding various data records when the information processing apparatus 1 is powered off.

The information processing apparatus 1 further includes a communication I/F 13. The information processing apparatus 1 is connected to a network 200 through the communication I/F 13. The communication I/F 13 is to access various pieces of information accessible via the network 200 based on the operation of the CPU 10. Specific examples of the communication I/F 13 include a USB port, a LAN port, and a wireless LAN port, and any port may be used as long as the communication I/F 13 can exchange data with external devices.

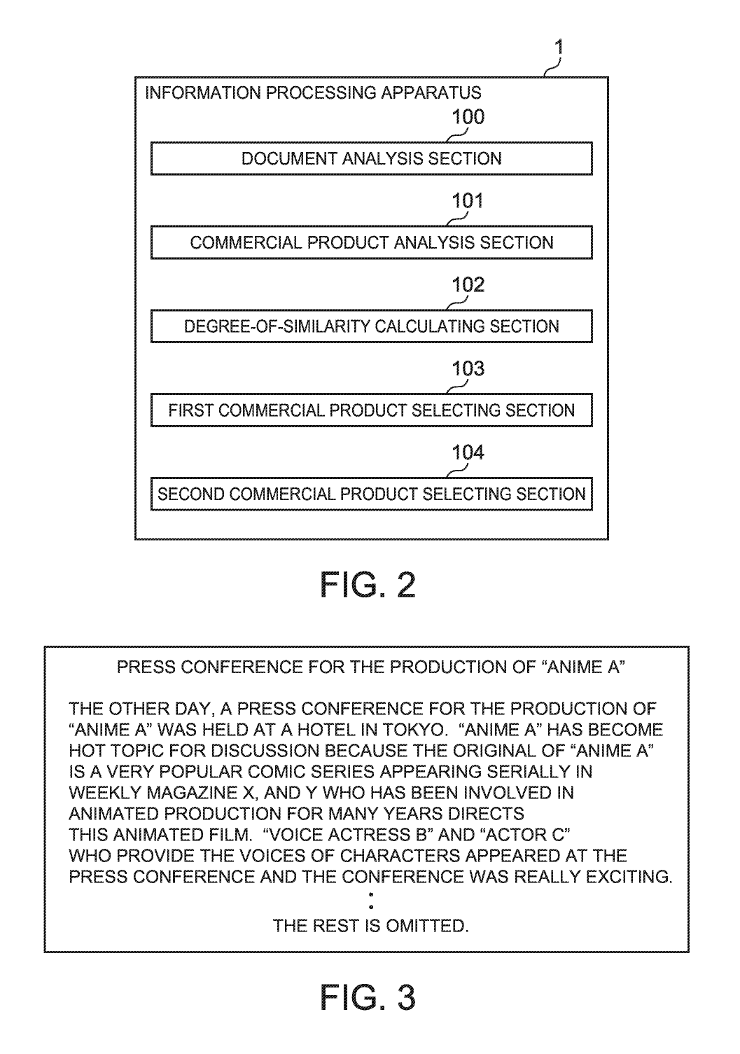

FIG. 2 is a functional block diagram of the information processing apparatus 1 according to the embodiment of the present invention. As illustrated in FIG. 2, the information processing apparatus 1 according to the present invention includes a document analysis section 100, a commercial product analysis section 101, a degree-of-similarity calculating section 102, a first commercial product selecting section 103, and a second commercial product selecting section 104.

The document analysis section 100 of the information processing apparatus 1 calculates a first word feature value representing the appearance frequency of each word in a specified document. In the embodiment, the “specified document” means text data and the like acquired via the network 200 based on a certain operation on a computer or by the user. For example, in the case of a personal computer equipped with a display device, the text data and the like acquired via the network 200 are displayed on the display device as the specified document. The “first word feature value” will be described later.

An example of the specified document is illustrated in FIG. 3. This is an example of text data acquired when a user accesses “Google” (registered trademark) or “Yahoo” (registered trademark) known as a search engine via the network 200. The specified document to be acquired is not limited to the text data, and it may include videos and images.

There is a morphological analysis as one of document analysis methods. The text that constitutes the specified document is decomposed into words by morphological analysis to extract the words. Further, for example, as known in the field of language analysis, words high in association in a word dictionary or the like provided in the HDD 12 or the like beforehand can be grouped and stored. For example, when a word used to refer to a person “B-o A-yama” is included in a group “B-o A-yama,” the family name “A-yama,” the first name “B-o,” a nickname, and the like are associated with the group “B-o A-yama” beforehand.

Therefore, when these words appear in a predetermined document, the words can be determined to belong to the group “B-o A-yama” without exception.

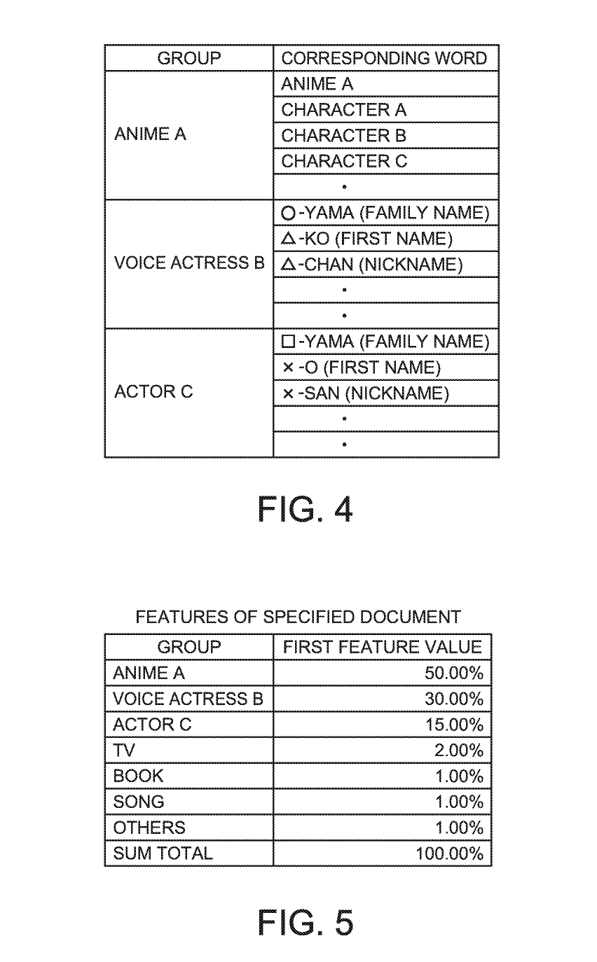

FIG. 4 is a table illustrating an example of grouping by morphological analysis. For example, a group “Anime A” is so defined that, when “Anime A,” “Character A,” “Character B,” and the like appear in the specified document, these words will be determined to belong to the group “Anime A” without exception. Similarly, a group “Voice Actress B” is so defined that, when “o-yama” as the family name, “Δ-ko” as the first name, and “Δ-chan” as the nickname of Voice Actress B appear in the specified document, these words will be determined to belong to the group “Voice Actress B” without exception. In the embodiment, the number of groups is limited to three groups for the sake of simplification, but the present invention is not limited thereto. Further, the grouping conditions vary. Thus, the specified document in FIG. 3 is morphologically analyzed to perform word analysis based on a predefined grouping rule.

FIG. 5 is a table illustrating an example of representing the features of the specified document as a result of grouping words appearing in the specified document of FIG. 3 based on the predefined grouping rule. Here, a first feature value is a value representing, as a weight, the total appearance frequency of words belonging to each group with respect to all words in the specified document. For example, in the case of the group “Anime A,” it means that the sum total of appearance frequencies of the words belonging to “Anime A” is 50% to 100% of the total weight of the specified document. The first feature values in the other groups are calculated in the same way. Since the number of words appearing in the text that constitute the specified document is huge, words are grouped to minimize the number of words in the embodiment. However, the first feature value of each of the words may be calculated as the appearance frequency of the word in the specified document without grouping the words. Further, the first feature value is not limited to the value in percentage, and it may be represented in fractional form.

In the document analysis section 100 of the information processing apparatus 1, the CPU 10 reads a program in which a predetermined document analysis scheme stored in the memory 11 is written to perform arithmetic processing and the like. The results of the arithmetic processing and the like are temporarily stored in the memory 11 and a storage device such as the HDD 12.

The commercial product analysis section 101 of the information processing apparatus 1 calculates a second word feature value representing the appearance frequency of each word in the description of each of commercial products. For example, the “commercial products” here mean commercial products provided to users from “Amazon” (registered trademark), “Rakuten” (registered trademark), and “iTunes” (registered trademark) as EC sites, information introduced for free to the users from sites such as “Gurunavi” (registered trademark), “Tabelog” (registered trademark), “Yelp” (registered trademark), and “Hotpepper” (registered trademark), or a wide variety of contents acquirable via the network 200 such as videos and images introduced for free to the users. The second word feature value will be described later.

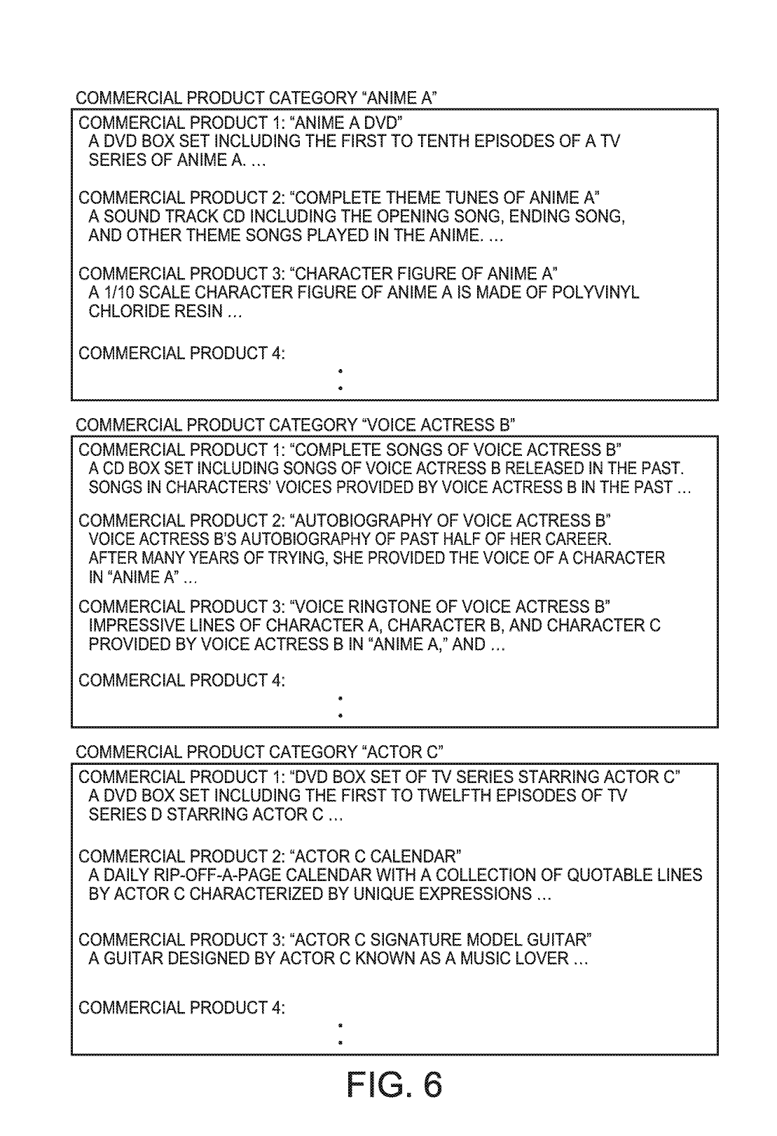

FIG. 6 is a diagram illustrating an example of information on commercial products. Information on commercial products may be acquired in advance from sites as mentioned above and stored in the HDD 12 or the like in a database format, or the information on the commercial products may be acquired at the timing of acquiring a specified document in such a manner to extract a keyword from the specified document based on a predetermined method and acquire information commercial products based on the keyword on a case-by-case basis. For example, in the case of a host computer or a server that originates a processing request to multiple computers through the network 200, it is possible to acquire the information on the commercial products in advance from the above-mentioned sites and store the information as a commercial product database. Further, for example, in addition to text information on the name of each commercial product or the description of the commercial product alone as in FIG. 6, it is possible to acquire together an image(s) and video(s) from which the appearance of the commercial product can be recognized. Further, as the text information, comments from users who used the commercial product, price information on the commercial product if a user thinks of buying the commercial product, and the like may be acquired together. Further, as information associated with the commercial product, it is also possible to acquire together advertisement price information such as an advertisement unit price when an advertisement for the commercial product is placed, the number of clicks on the displayed advertisement, and the number of advertisement displays.

As one of commercial product analysis methods, morphological analysis is used like the analysis method in the document analysis section 100. Using the morphological analysis, the text that constitutes the name of each commercial product and the description of the commercial product in FIG. 6 is decomposed into words to extract the words. Further, like the analysis method in the document analysis section 100, words high in association with one another in a word dictionary or the like provided in advance in the HDD 12 or the like can be grouped.

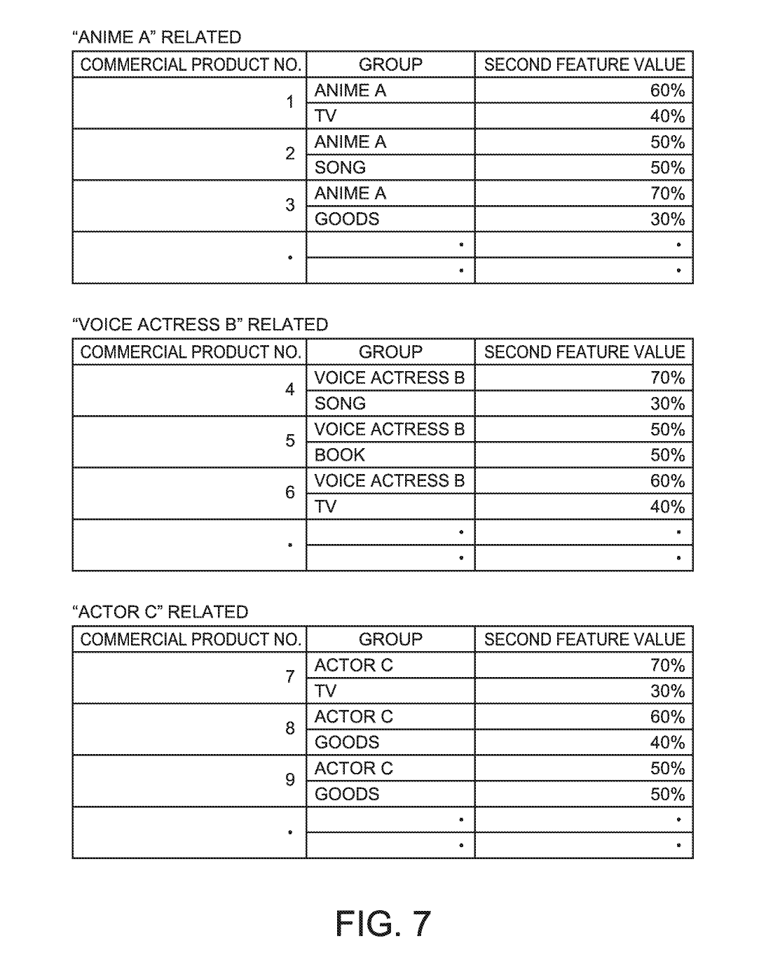

FIG. 7 is a table illustrating an example in which words appearing in the name of each commercial product and the description of the commercial product in FIG. 6 are grouped in advance based on the grouping rule to represent the features of the commercial product. The second feature value here means a value representing, by a weight, the total appearance frequency of words belonging to each group with respect to the appearance frequencies of all words appearing in the name of each commercial product and the description of the commercial product. For example, in the case of a commercial product No. 1, it means that the percentage of the total appearance frequency of words belonging to the group “Anime A” relative to the total weight 100% of all words appearing in the commercial product name of the commercial product No. 1 and the description of the commercial product is 60%, and the percentage of the total appearance frequency of words belonging to the group “TV” is 40%. Similarly, groups of commercial products are set for commercial products of commercial product No. 2 to No. 9, and second feature values are calculated. In the embodiment, the commercial products are divided into categories “Anime A,” “Voice Actress B,” and “Actor C” for the sake of simplification, but the second word feature value of each of words appearing in the description of each of commercial products may be calculated for each commercial product as the appearance frequency of the word in the description of the commercial product without dividing the commercial products into categories. It is also possible to store the commercial products in association with unique IDs, rather than the commercial product Nos.

In the commercial product analysis section 101 of the information processing apparatus 1, the CPU 10 reads a program in which a predetermined commercial product analysis scheme stored in the memory 11 is written to perform arithmetic processing and the like. The results of the arithmetic processing and the like are temporarily stored in the memory 11 and a storage device such as the HDD 12.

The degree-of-similarity calculating section 102 of the information processing apparatus 1 calculates a degree of similarity between the specified document and each commercial product based on the first word feature values of the specified document and the second word feature values of the commercial product. In the embodiment, as an example of calculating the degree of similarity between two comparison targets, the degree of similarity between the specified document and the commercial product is calculated using the degree of cosine similarity.

For example, there is known a method of calculating the degree of cosine similarity using, as a word vector component, the number of appearances of each of words appearing in the text. In the embodiment, when the first feature values of respective groups in FIG. 5 are used as word vector components of the specified document, the word vector components can be defined as (0.5, 0.3, 0.15, 0.02, 0.01, 0.01, 0.01). Then, for example, when the second feature values of the commercial product No. 1 in FIG. 7 are used as word vector components of the commercial product, the word vector components can be defined as (0.6, 0, 0, 0.4, 0, 0, 0). Similarly, the word vector components can be defined for the commercial products No. 2 to No. 9.

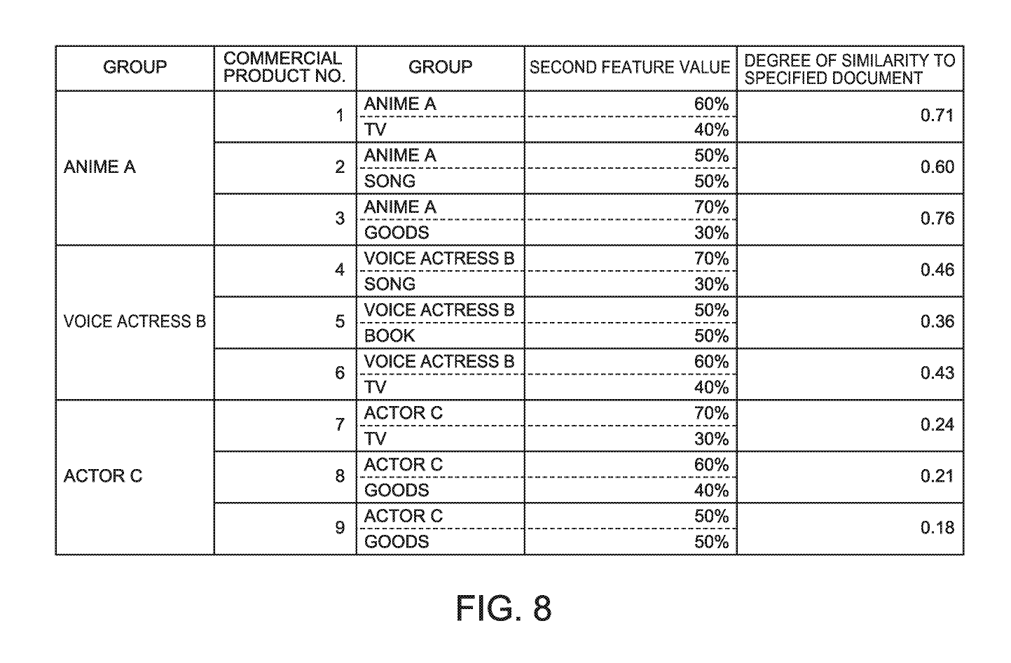

As mentioned above, the degree of cosine similarity can be calculated using the word vector components of the specified document and the word vector components of each commercial product. Since the calculation formula of the degree of cosine similarity is known, the detailed description of the calculation method will be omitted. The calculation results for the commercial products No. 1 to No. 9 are illustrated in FIG. 8, respectively. It is found from FIG. 8 that a commercial product highest in degree of similarity to the specified document among commercial products of the commercial products No. 1 to No. 9 is the commercial product No. 3 whose degree of similarity is 0.76. It is also found that a commercial product lowest in degree of similarity is the commercial product No. 9 whose degree of similarity is 0.18. Note that the method of calculating the degree of similarity is not limited to that of calculating the degree of cosine similarity, and Euclidean distance or the like may also be used.

In the degree-of-similarity calculating section 102 of the information processing apparatus 1, the CPU 10 reads a program in which a predetermined calculation formula for the degree of similarity stored in the memory 11 is written to perform the arithmetic processing and the like. The calculated degree of similarity is stored in association with the second feature values of each commercial product stored in the memory 11 and a storage device such as the HDD 12.

The first commercial product selecting section 103 of the information processing apparatus 1 selects a first commercial product associated with the specified document based on the degree of similarity. The commercial product selected here is a commercial product highest in degree of similarity, that is, the commercial product of the commercial product No. 3 is selected from FIG. 8. In the embodiment, the number of commercial products is assumed to be nine, but a predetermined threshold value for the degree of similarity may be so preset that commercial products whose degrees of similarity are equal to or less than the threshold value will be excluded from the selection.

In the first commercial product selecting section 103 of the information processing apparatus 1, the CPU 10 reads a program, in which a predetermined commercial product selecting scheme stored in the memory 11 is written, and degree-of-similarity information on commercial products to perform the arithmetic processing and the like. The information selected as the first commercial product is temporarily stored in the memory 11 and a storage device such as the HDD 12.

### First Example of Selecting Commercial Product Based on Diversity

The second commercial product selecting section 104 of the information processing apparatus 1 selects a second commercial product associated with the specified document based on diversity calculated from the second word feature values of the selected first commercial product and the second word feature values of the commercial product, and the degree of similarity. Here, it is assumed that the “selected first commercial product” is the commercial product No. 3. It is also assumed that the “second commercial product” is any one of unselected commercial product Nos. 1, 2, and 4 to 9. The “diversity” will be described below.

In the embodiment, a first commercial product highest in degree of similarity to the specified document is preferentially selected, and each second commercial product is evaluated from the standpoint of “diversity” in consideration of the degree of similarity to the specified document and variations of commercial products to acquire a second commercial product having a high evaluated value preferentially. In the embodiment, information entropy is used as one of ways to think of “diversity.” The information entropy is to quantify the volume of information based on the probability of an event, and use of the information entropy to determine the selection of a commercial product in the embodiment can be said to be appropriate. However, from the standpoint of quantifying information, “diversity” is not limited to the information entropy. For example, Kullback-Leibler divergence used in the concept of information gain may also be used.

In the following, values of information entropy indicative of diversity will be calculated. First, in the embodiment, it is assumed that events in the information entropy are word vector components of “Anime A,” “Voice Actress B,” “Actor C,” and the like. Then, second feature values of the word vector components are synthesized each time a commercial product is selected. At the moment, the word vector components (“Anime A” and “Goods”) of the selected commercial product No. 3 as the first commercial product are represented as (0.7, 0.3).

Next, word vector components of unselected commercial product Nos. 1, 2, and 4 to 9 are synthesized, respectively. For example, when the word vector components of the commercial product No. 1 are synthesized with those of the commercial product No. 3, the word group after the synthesis is represented as (“Anime A, “Goods,” “TV”), and the results of synthesizing respective word vector components are (1.3, 0.3, 0.4). As for “Anime A” as the duplication event of the commercial product No. 3 and the commercial product No. 1, the word vector components are simply added as 0.7+0.6. Then, “TV” as a new event to the commercial product No. 3 is newly added.

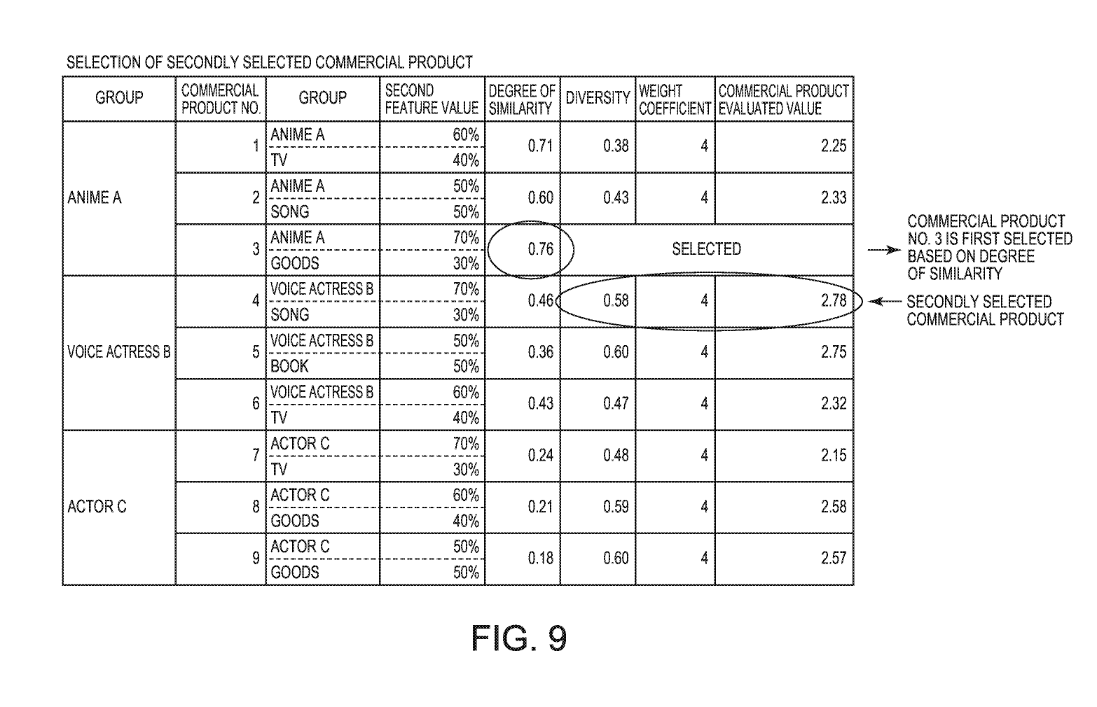

Thus, the information entropy can be calculated by synthesizing the word vector components of an unselected commercial product with the word vector components of the selected commercial product. The arithmetic expression of information entropy H is known and represented as H=−ΣPᵢ log Pᵢ. In this case, Pᵢ can be represented as the proportion of a specific word vector component to all the word vector components. For example, when the number of all word vector components is 2, the proportion of the synthesized word vector component of “Anime A” is represented as 1.3/2. Similarly, “Goods” is represented as 0.3/2, and “TV” is represented as 0.4/2. When each of these values is applied to the arithmetic expression of information entropy H for each event, a value of 0.38 is calculated for the event of the commercial product No. 1, as illustrated in FIG. 9. Note that each value corresponding to “diversity” in FIG. 9 is the value of information entropy H. Similarly, the information entropy H is calculated for each of the commercial product Nos. 2, and 5 to 9, respectively.

Using the information entropy H obtained as mentioned above, the unselected commercial products are evaluated. In the embodiment, it is assumed that the evaluated value of each commercial product is represented in an equation as Degree of Similarity+(Weight Coefficient×H) using the degree of similarity and the information entropy H. The weight coefficient is any given value. The diversity, i.e. the value of information entropy is more counted as the value of the weight coefficient increases, while the degree of similarity is more counted as the value of the weight coefficient decreases. As this value, for example, an optimum value can also be set by analyzing documents actually acquired from general sites. In the embodiment, a numerical value of 4 is used as the weight coefficient as an example, but the weight coefficient is not limited to this numerical value. Any other value may be used as long as each commercial product can be evaluated in consideration of the concept of diversity.

As a result of calculating the evaluated values of the unselected commercial products based on the above arithmetic expression, the commercial product No. 4 is found to have the largest numerical value. In other words, the commercial product as a secondly selected commercial product is the commercial product of the commercial product No. 4. Although a commercial product such as the commercial product No. 1 or the commercial product No. 2 high in degree of similarity to the specified document is preferentially selected in the conventional, the commercial product of the commercial product No. 4 lower in degree of similarity than the commercial product No. 1 or the commercial product No. 2 can be preferentially selected as the secondly selected commercial product in light of the concept of diversity. Like in the first commercial product selection, a predetermined threshold value may be set in advance for the degree of similarity to perform preprocessing first for excluding commercial products smaller than the threshold value from the selection.

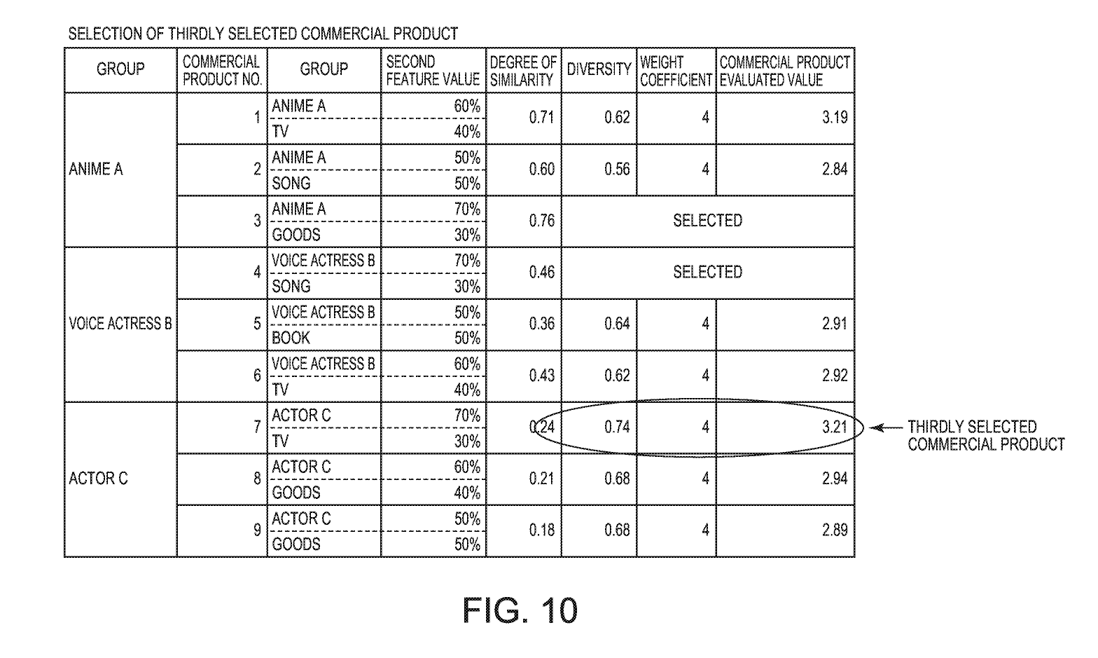

Next, a thirdly selected commercial product is selected. Like in the case of selecting the secondarily selected commercial product, the information entropy H for selecting each of unselected commercial products Nos. 1, 2, and 5 to 9 based on the word vector components of (0.7, 0.3, 0.7, 0.3) (“Anime A” and “Goods,” “Voice Actress B” and “Music”) obtained respectively by synthesizing the selected commercial products No. 3, and No. 4 is calculated to calculate an evaluated value of each commercial product. The calculation results are illustrated in FIG. 10, where the commercial product No. 7 has the largest numerical value. In other words, a commercial product as a thirdly selected commercial product is the commercial product of the commercial product No. 7.

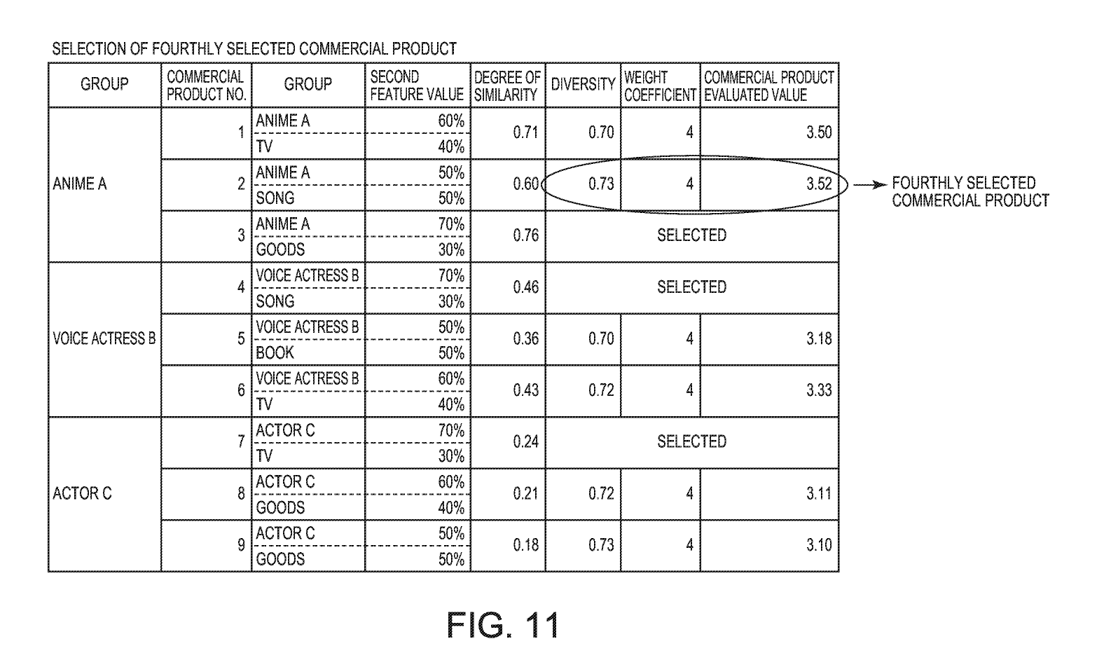

Next, a fourthly selected commercial product is selected. Like in the cases of selecting the secondly selected commercial product and the thirdly selected commercial product, the information entropy H for selecting each of unselected commercial product Nos. 1, 2, 5, 6, 8, and 9 based on the word vector components of (0.7, 0.3, 0.7, 0.3, 0.7, 0.3) (“Anime A” and “Goods,” “Voice Actress B” and “Music,” “Actor C” and “TV”) obtained respectively by synthesizing the selected commercial products Nos. 3, 4, and 7 is calculated to calculate an evaluated value of each commercial product. The calculation results are illustrated in FIG. 11, where the commercial product No. 2 has the largest numerical value. In other words, a commercial product to be selected as the fourthly selected commercial product is the commercial product of the commercial product No. 2. After that, the selection of a second commercial product is repeated until a given number of selections are fulfilled.

Thus, in the embodiment, the order of selecting commercial products is such that a commercial product associated with “Anime A” is first selected based on the degree of similarity, a commercial product associated with “Voice Actress B” is next selected based on the diversity evaluation, and a commercial product associated with “Actor C” is further selected. In the conventional selection based on the degree of similarity, the commercial product associated with “Anime A” is preferentially selected, while in the embodiment, commercial products in different categories such as “Anime A,” “Voice Actress B,” and “Actor C” can be selected in a balanced manner.

In the second commercial product selecting section 104 of the information processing apparatus 1, the CPU 10 reads a program in which a predetermined commercial product selecting scheme stored in the memory 11 is written, degree-of-similarity information on commercial products, and information on second feature values to perform the arithmetic processing and the like. The information selected as the second commercial products are temporarily stored in the memory 11 and a storage device such as the HDD 12.

### Second Example of Selecting Commercial Product Based on Diversity

A second example of selecting a commercial product based on diversity will be described. When commercial products and the like listed in FIG. 6 are placed in the specified document as advertisements, individuals or companies can get advertising revenues by placing the advertisements. The advertising unit price is set for each commercial product, and an advertising revenue is determined based on the advertising unit price. The advertising revenue earned by placing an advertisement varies on a case-by-case basis. The advertising revenue may be calculated when a contract for placing an advertisement is concluded, calculated based on the number of times the advertisement is displayed on each of information terminals of users, or calculated based on the number of user clicks on the displayed advertisement.

As the second example of selecting a commercial product based on diversity, the commercial product is selected based on information on the advertisement price of the commercial product. As the example here, only commercial products that meet a predetermined threshold value are first narrowed down based on the degree of similarity between the specified document and each commercial product calculated by the degree-of-similarity calculating section 102. In processing here, the CPU 10 first reads the predetermined threshold value prestored in the memory 11 and performs arithmetic processing and the like based on a program. Next, a first commercial product associated with the specified document is selected based on the advertisement price information from among the commercial products that meet a predetermined degree of similarity.

The advertisement price information as a selection criterion to select the first commercial product may be the advertisement unit price itself, or a numerical value obtained by weighting the advertisement unit price with the number of user clicks on the displayed advertisement, the number of times the advertisement is displayed, or the like. It is preferred that the first commercial product to be selected should be a commercial product high in advertisement unit price or a commercial product having information indicating that an advertisement price with a predetermined weight is high. Next, a second commercial product associated with the specified document is selected based on the diversity calculated from the word feature value of the selected first commercial product and the word feature value of each of unselected commercial products, and the advertisement price information. For example, like in the first example, the “word feature value of the first commercial product” and the “word feature value of each of unselected commercial product” here can be represented in such a manner that the total appearance frequency of words belonging to each group is represented by a weight with respect to the appearance frequencies of all words appearing in the name of each commercial product and the description of the commercial product as illustrated in FIG. 7. The appearance frequency of each of the words appearing in the description of each commercial product may also be represented as the appearance frequency of each word in the description of the commercial product without grouping.

For example, like in the first example, the information entropy H may be used for the “diversity.” Giving such a definition can derive a calculation formula of Advertisement Price Information+(Weight Coefficient×Information Entropy) to calculate the evaluated value of each commercial product as an unselected second commercial product. The weight coefficient is any given value. The diversity, i.e. the value of information entropy is more counted as the value of the weight coefficient increases, while the advertisement price information is more counted as the value of the weight coefficient decreases. Like in the first example, the word vector components of each of unselected commercial products are synthesized with the word vector components of the selected commercial product to select a second commercial product in consideration of the diversity between the selected commercial product and the unselected commercial product. After that, the selection of a second commercial product is repeated until a given number of selections are fulfilled.

Thus, in the second example, commercial products high in similarity between the specified document and the commercial products are narrowed down to be able to select a commercial product in consideration of the advertisement price information on the commercial product and the diversity. Since the commercial product is thus selected, a variety of commercial products can be selected while keeping similarities to the specified document without a bias to commercial products high in advertisement unit price or commercial products with high advertisement price information.

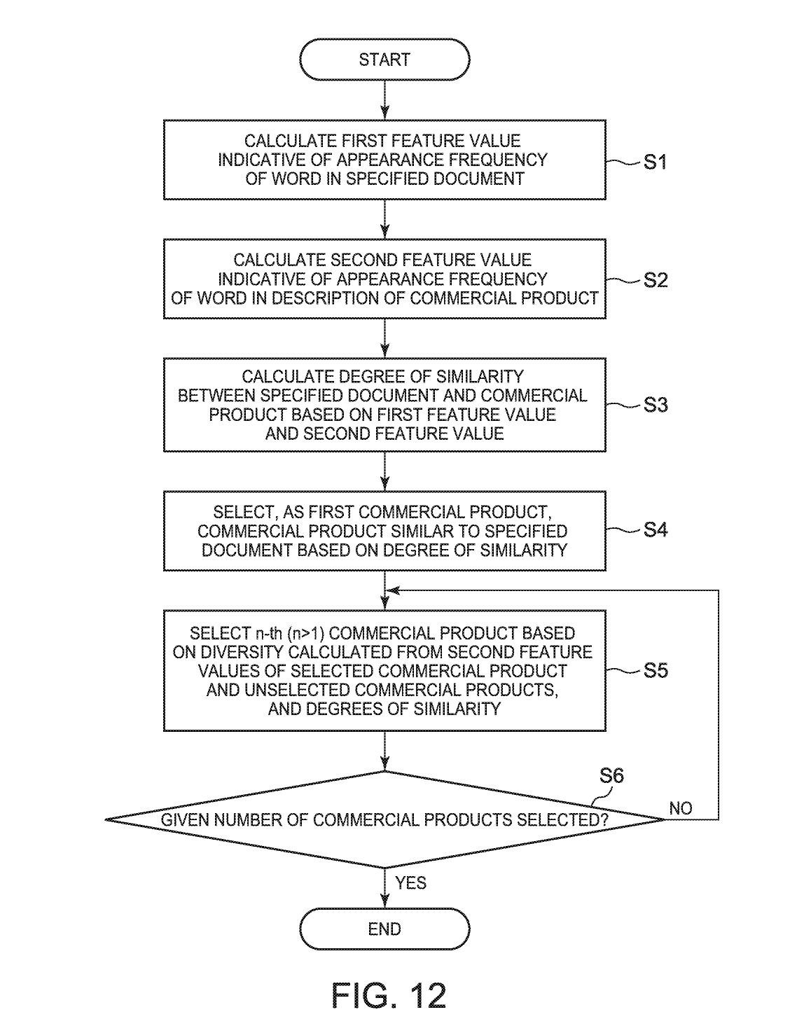

FIG. 12 is an example of a flowchart of selecting commercial products according to the embodiment of the present invention.

First, a first feature value indicative of the appearance frequency of each word in a specified document is calculated (step 1). Then, a second feature value indicative of the appearance frequency of each word in the description of each commercial product is calculated (step 2). Based on the first feature value and the second feature value, a degree of similarity between the specified document and the commercial product is calculated (step 3).

Based on the degree of similarity, a commercial product similar to the specified document is selected as a first commercial product (step 4). Then, based on diversity calculated from the second feature values of the selected first commercial product and unselected commercial products, and the degree of similarity, a second commercial product is selected (step 5). After that, the processing in step 5 is repeated until a given number of selections are fulfilled (step 6).

Note that the contents equipped in an apparatus used and the number of apparatuses are not limited to those in the embodiment as long as the configuration can carry out the present invention.

We claim:

1. An information processing apparatus comprising:
a document analysis section that calculates a first word feature value indicative of an appearance frequency of a word in a specified document;
a commercial product analysis section that calculates a second word feature value indicative of an appearance frequency of a word in a description of a commercial product;
a degree-of-similarity calculating section that calculates a degree of similarity between the specified document and the commercial product based on the first word feature value of the specified document and the second word feature value of the commercial product;
a first commercial product selecting section that selects a first commercial product associated with the specified document based on the degree of similarity; and
a second commercial product selecting section that selects a second commercial product associated with the specified document based on a diversity calculated from the second word feature value of the selected first commercial product and the second word feature value of each of unselected commercial products, and the degree of similarity.

2. The information processing apparatus according to claim 1, wherein the first commercial product selecting section selects, as the first commercial product associated with the specified document, the first commercial product whose degree of similarity is larger than a predetermined threshold value.

3. The information processing apparatus according to claim 1, wherein the second commercial product selecting section selects the second commercial product associated with the specified document based on a weighted diversity, obtained by multiplying a weight coefficient by the diversity calculated from the second word feature value of the selected first commercial product and the second word feature value of each of the unselected commercial products, and a degree of similarity that is larger than the predetermined threshold value.

4. The information processing apparatus according to claim 1, wherein the second commercial product selecting section selects the second commercial product associated with the specified document based on information entropy calculated from word vector components of the selected first commercial product and word vector components of each of the unselected commercial products, and a degree of similarity that is larger than the predetermined threshold value.

5. The information processing apparatus according to claim 1, wherein the second commercial product selecting section selects the second commercial product until a given number of selections are fulfilled.

6. An information processing apparatus comprising:
a document analysis section that calculates a first word feature value indicative of an appearance frequency of a word in a specified document;
a commercial product analysis section that calculates a second word feature value indicative of an appearance frequency of a word in a description of a commercial product;
a degree-of-similarity calculating section that calculates a degree of similarity between the specified document and the commercial product based on the first word feature value of the specified document and the second word feature value of the commercial product;
a commercial product limiting section that narrows down commercial products to only commercial products whose degrees of similarity meet a predetermined threshold value;
a first commercial product selecting section that selects, from the narrowed down commercial products, a first commercial product associated with the specified document based on advertisement price information related to advertising of the commercial products; and
a second commercial product selecting section that selects a second commercial product associated with the specified document based on a diversity calculated from the second word feature value of the selected first commercial product and the second word feature value of each of the unselected commercial products, and the advertisement price information of the commercial products.

7. An information processing method comprising:
calculating a first word feature value indicative of an appearance frequency of a word in a specified document;
calculating a second word feature value indicative of an appearance frequency of a word in a description of a commercial product;
calculating a degree of similarity between the specified document and the commercial product based on the first word feature value of the specified document and the second word feature value of the commercial product;
selecting a first commercial product associated with the specified document based on the degree of similarity; and
selecting a second commercial product associated with the specified document based on a diversity calculated from the second word feature value of the selected first commercial product and the second word feature value of each of unselected commercial products, and the degree of similarity.
